(19) United States
(12) Patent Application Publication
(10) Pub. No.: US 2018/0086952 A1
(43) Pub. Date: Mar. 29, 2018

(54) ADHESIVE COMPOSITION AND LAMINATED FILM

(71) Applicant: TAIFLEX Scientific Co., Ltd., Kaohsiung (TW)

(72) Inventors: I-Ling Teng, KAOHSIUNG (TW); Tzu-Ching Hung, KAOHSIUNG (TW); Chiao-Pei Chen, KAOHSIUNG (TW); Yu-Hsien Lee, KAOHSIUNG (TW); Tsung-Tai Hung, KAOHSIUNG (TW); Bo-Sheng Wang, KAOHSIUNG (TW); Cheng-Yen Hsiao, KAOHSIUNG (TW); Chen-Hsin Huang, KAOHSIUNG (TW)

(73) Assignee: TAIFLEX Scientific Co., Ltd., KAOHSIUNG (TW)

(21) Appl. No.: 15/358,148

(22) Filed: Nov. 22, 2016

(30) Foreign Application Priority Data
Sep. 29, 2016 (TW) 105131195

(51) Int. Cl. C09J 125/08; B32B 7/12; B32B 15/08

(52) U.S. Cl. CPC C09J 125/08; C08K 5/098; B32B 15/08; B32B 7/12

(57) ABSTRACT

An adhesive composition is provided. The adhesive composition includes a mixture (A), wherein the mixture (A) includes a first component (a), a cross-linking agent (b), and a second component (c), wherein the second component (c) includes a calcium-containing complex compound or a calcium-containing compound. Based on the total weight of the mixture (A), a content of the first component (a) is from 40 to 80 wt %, a content of the cross-linking agent (b) is from 20 to 60 wt %, and a content of the second component (c) is from 1 to 20 wt %. Specifically, the calcium-containing complex compound is selected from the group consisting of a compound represented by formula (1), a compound represented by formula (2), a compound represented by formula (3), and a compound represent by formula (4), and the calcium-containing compound is selected from the group consisting of a compound represented by formula (5) and a compound represent by formula (6).

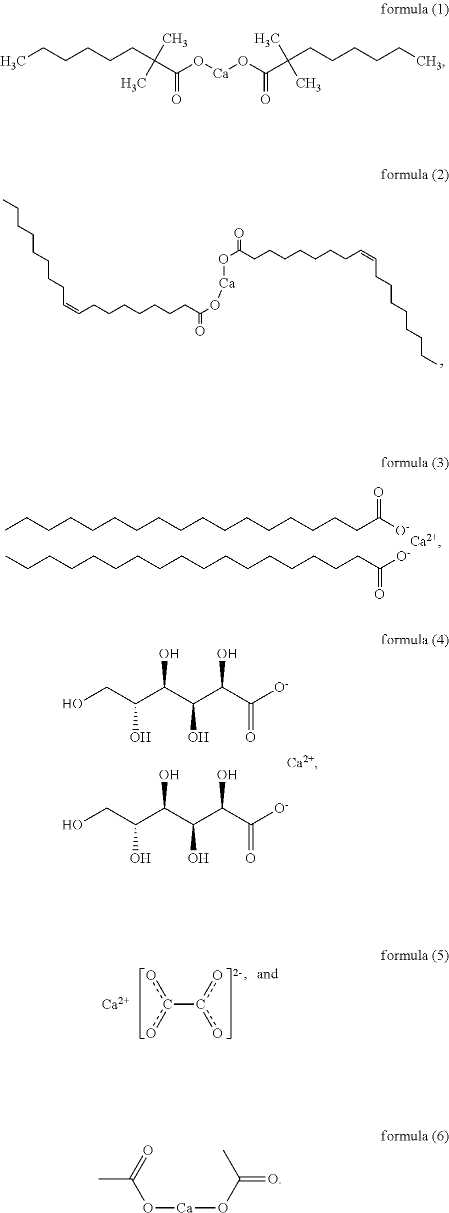

### CROSS-REFERENCE TO RELATED APPLICATION

This application claims the priority benefit of Taiwan application serial no. 105131195, filed on Sep. 29, 2016. The entirety of the above-mentioned patent application is hereby incorporated by reference herein and made a part of this specification.

### BACKGROUND OF THE INVENTION

### Field of the Invention

The invention relates to an adhesive composition and a laminated film, and particularly relates to an adhesive composition having corrosion resistance and a laminated film including an adhesive glue layer formed by the adhesive composition.

### Description of Related Art

The lithium ion battery is used as a storage battery for, for instance, a portable device such as a personal computer or a mobile phone, a hybrid vehicle, or an electric car. With the increasing market demand for the lithium ion battery having the characteristics of, for instance, repeated charge and discharge, lightweight, high voltage value, and high energy density, the demand for performance of the lithium ion battery in, for instance, longer lifetime and high safety is also rising.

In general, an aluminum plastic film used for packaging the lithium ion battery is a laminated film, wherein the laminated film of a metal layer having aluminum foil is easily corroded by corrosive substances, and then resulting in defects. For example, as the lithium ion battery is packaged by the aluminum plastic film, the aluminum foil in the laminated film is corroded by acidic substances generated from the electrolytic solution of the lithium ion battery and then causes delamination defects, in which greatly affected the lifetime and safety of the lithium ion battery.

To prevent the aluminum foil in the laminated film being corroded by acidic substances generated from the electrolytic solution of the lithium ion battery; in conventional methods, a metal treatment layer is formed on the aluminum foil by performing a metal treatment process before manufacturing the aluminum plastic film. Specifically, the metal treatment layer is anti-corrosive and entirely covers the aluminum foil in the laminated film. Due to the anti-corrosion of the metal treatment layer, it can effectively avoid a decrease of product yield that is caused by the aluminum foil in the laminated film being corroded by the acidic substances generated from the electrolytic solution of the lithium ion battery.

Thus, improving the defects that are caused by corrosion of the acidic substances in order to meet the industry requirements is one of the desired goals to those skilled in the art.

### SUMMARY OF THE INVENTION

The invention provides an adhesive composition and a laminated film, and particularly relates to an adhesive composition having corrosion resistance and a laminated film including an adhesive glue layer formed by the adhesive composition.

The invention provides an adhesive composition including a mixture (A), wherein the mixture (A) includes a first component (a), a cross-linking agent (b), and a second component (c), wherein the second component (c) includes a calcium-containing complex compound or a calcium-containing compound. Based on the total weight of the mixture (A), a content of the first component (a) is from 40 to 80 wt %, a content of the cross-linking agent (b) is from 20 to 60 wt %, and a content of the second component (c) is from 1 to 20 wt %. Specifically, the calcium-containing complex compound is selected from the group consisting of a compound represented by formula (1), a compound represented by formula (2), a compound represented by formula (3), and a compound represent by formula (4), and the calcium-containing compound is selected from the group consisting of a compound represented by formula (5) and a compound represent by formula (6).

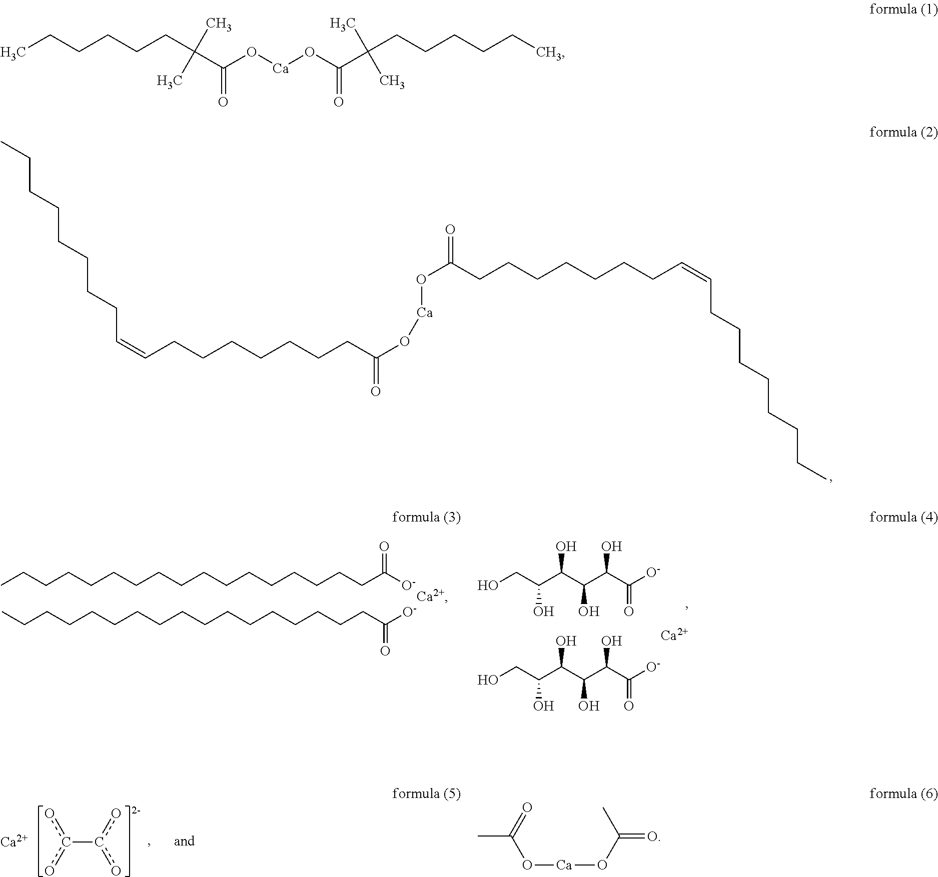

According to an embodiment of the invention, the first component (a) includes a resin having a reactive functional group, wherein the reactive function group is selected from the group consisting of a carboxy group, an amino group, an epoxy group, a hydroxy group and a double bond.

According to an embodiment of the invention, the cross-linking agent (b) includes an aromatic compound having at least two reactive functional groups, an aliphatic compound having at least two reactive functional groups, and a combination thereof, wherein the reactive functional groups is selected from the group consisting of a carboxy group, an anhydride group, an amino group, a hydroxy group, epoxy group, an isocyanate group and a double bond.

According to an embodiment of the invention, the mixture (A) further includes a catalyst (d), wherein based on the total weight of the mixture (A), a content of the catalyst (d) is from 0 to 10 wt %.

According to an embodiment of the invention, the adhesive composition further includes a solvent (B), wherein based on 100 wt % of the mixture (A), a content of the solvent (B) is from 20 to 80 wt %.

The invention provides a laminated film including a substrate and an adhesive glue layer disposed thereon, wherein the adhesive glue layer is formed by the aforesaid adhesive composition.

According to an embodiment of the invention, a material of the substrate is selected from the group consisting of metals, organic materials and inorganic materials.

The invention provides a laminated film including a metal layer, a first resin layer, a second resin layer, and an adhesive glue layer. The metal layer has a first surface and a second surface opposite to each other. The first resin layer is disposed on the first surface of the metal layer. The second resin layer is disposed on the second surface of the metal layer. The adhesive glue layer is disposed between the metal layer and the first resin layer, wherein the adhesive glue layer is formed by an adhesive composition including a mixture (A), and the mixture (A) includes a first component (a), a cross-linking agent (b) and a second component (c). Based on the total weight of the mixture (A), a content of the first component (a) is from 40 to 80 wt %, a content of the cross-linking agent (b) is from 20 to 60 wt %, and a content of the second component (c) is from 1 to 20 wt %. The second component (c) includes a calcium-containing complex compound or a calcium-containing compound, wherein the calcium-containing complex compound is selected from the group consisting of a compound represented by formula (1), a compound represented by formula (2), a compound represented by formula (3), and a compound represent by formula (4), and the calcium-containing compound is selected from the group consisting of a compound represented by formula (5) and a compound represent by formula (6).

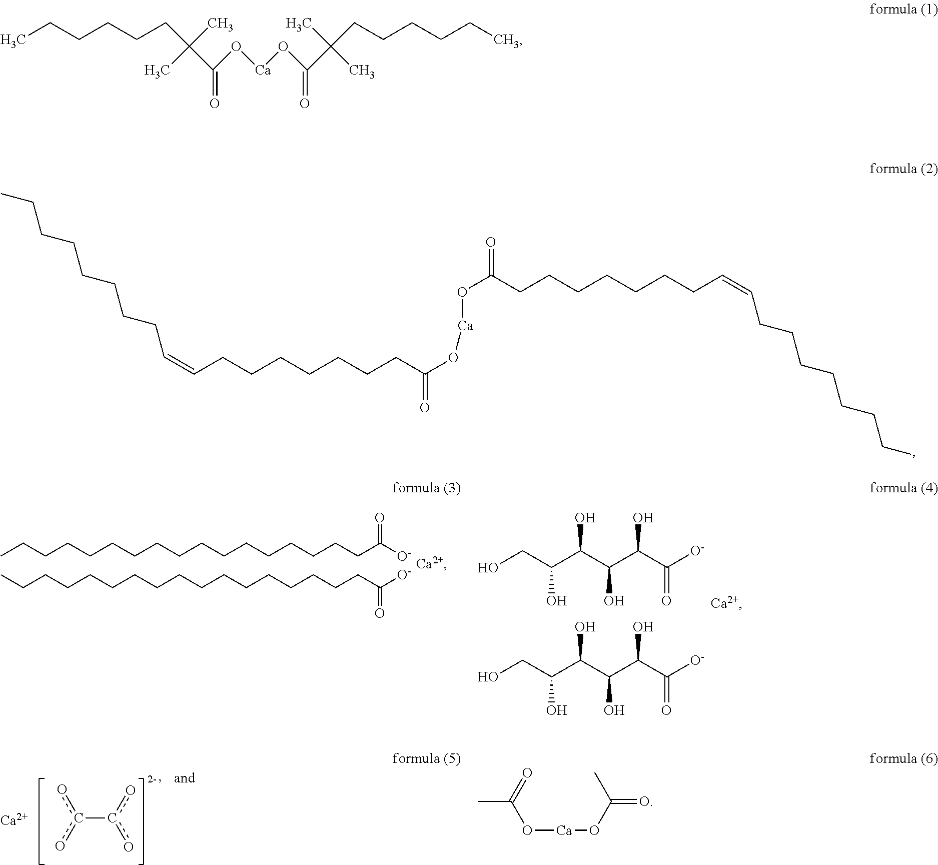

According to an embodiment of the invention, the first component (a) includes a resin having a reactive functional group, wherein the reactive function group is selected from the group consisting of a carboxy group, an amino group, an epoxy group, a hydroxy group and a double bond.

According to an embodiment of the invention, the cross-linking agent (b) includes an aromatic compound having at least two reactive functional groups, an aliphatic compound having at least two reactive functional groups, and a combination thereof, wherein the reactive functional groups is selected from the group consisting of a carboxy group, an anhydride group, an amino group, a hydroxy group, epoxy group, an isocyanate group and a double bond.

According to an embodiment of the invention, the mixture (A) further includes a catalyst (d), wherein based on the total weight of the mixture (A), a content of the catalyst (d) is from 0 to 10 wt %.

According to an embodiment of the invention, the adhesive composition further includes a solvent (B), wherein based on 100 wt % of the mixture (A), a content of the solvent (B) is from 20 to 80 wt %.

According to an embodiment of the invention, a thickness of the metal layer is between about 30 μm (micrometer) to 40 μm.

According to an embodiment of the invention, a thickness of the first resin layer is between about 20 μm to 80 μm.

According to an embodiment of the invention, a thickness of the second resin layer is between about 15 μm to 25 μm.

According to an embodiment of the invention, a thickness of the adhesive glue layer is between about 3 μm to 5 μm.

According to an embodiment of the invention, the laminated film further includes an adhesive layer disposed between the metal layer and the second resin layer, wherein a thickness of the adhesive layer is between about 3 μm to 5 μm.

According to an embodiment of the invention, the laminated film further includes a metal treatment layer disposed between the metal layer and the adhesive layer, wherein a thickness of the metal treatment layer is between about 10 nm (nanometer) to 200 nm.

Based on the above, the adhesive composition of the invention has corrosion resistance, as such the adhesive glue layer made from the adhesive composition of the invention is capable of having good corrosion resistance in addition to good adhesion. Accordingly, the laminated film having the same is anti-corrosive, which is capable of achieving the effect of corrosion resistance, thereby enhancing the lifetime and safety of the laminated film.

In order to make the aforementioned features and advantages of the disclosure more comprehensible, embodiments are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view illustrating a laminated film according to an embodiment of the invention.

FIG. 2 is a schematic cross-sectional view illustrating a laminated film according to another embodiment of the invention.

FIG. 3A to 3C are schematic cross-sectional view illustrating the processes of a method of fabricating a laminated film according to an embodiment of the invention.

FIG. 4 is a schematic cross-sectional view illustrating a laminated film according to another embodiment of the invention.

### DESCRIPTION OF THE EMBODIMENTS

In the specification, scopes represented by “a numerical value to another numerical value” are schematic representations in order to avoid listing all of the numerical values in the scopes in the specification. Therefore, the recitation of a specific numerical range covers any numerical value in the numerical range and a smaller numerical range defined by any numerical value in the numerical range, as is the case with any numerical value and a smaller numerical range thereof in the specification.

<Adhesion Composition>

The invention provides an adhesion composition including a mixture (A). Moreover, the adhesion composition can further include a solvent (B). In the following, each component of the adhesion composition of the invention is described in detail.

Mixture (A)

The mixture (A) includes a first component (a), a cross linking agent (b), and a second component (c). Additionally, the mixture (A) can further include a catalyst (d).

The first component (a) includes a resin having a reactive functional group, wherein the reactive function group is selected from the group consisting of a carboxy group, an amino group, an epoxy group, a hydroxy group and a double bond. In some embodiments, the first component (a) can be used alone or in multiple combinations, the invention is not limited thereto.

Based on the total weight of the mixture (A), a content of the first component (a) is from 40 to 80 wt %, preferably from 45 to 60 wt %, and more preferably about 50 wt %.

The cross-linking agent (b) includes an aromatic compound having at least two reactive functional groups, an aliphatic compound having at least two reactive functional groups, and a combination thereof, wherein the reactive functional groups is selected from the group consisting of a carboxy group, an anhydride group, an amino group, a hydroxy group, epoxy group, an isocyanate group and a double bond. In some embodiments, the cross-linking agent (b) can be used alone or in multiple combinations, the invention is not limited thereto.

Based on the total weight of the mixture (A), a content of the cross-linking agent (b) is from 20 to 60 wt %, preferably from 25 to 45 wt %, and more preferably about 40 wt %. When the cross-linking agent (b) is used, the adhesive glue layer made from the adhesive composition has superior film-forming capability.

The second component (c) includes a calcium-containing complex compound or a calcium-containing compound.

In some embodiments, the calcium-containing complex compound is selected from the group consisting of a compound represented by formula (1), a compound represented by formula (2), a compound represented by formula (3), and a compound represent by formula (4).

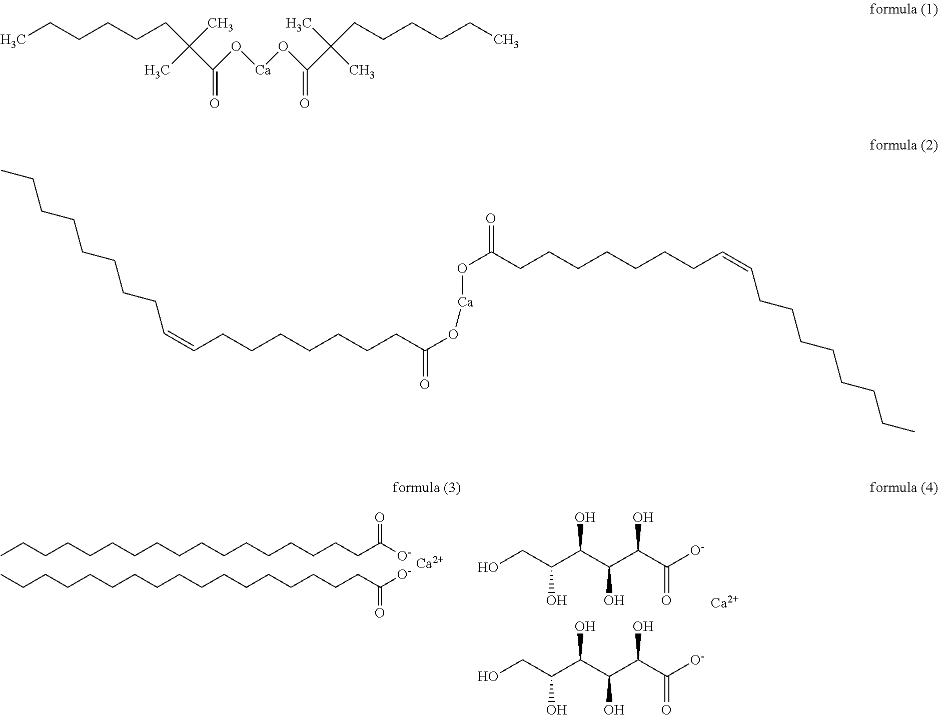

In some embodiments, the calcium-containing compound is selected from the group consisting of a compound represented by formula (5) and a compound represent by formula (6).

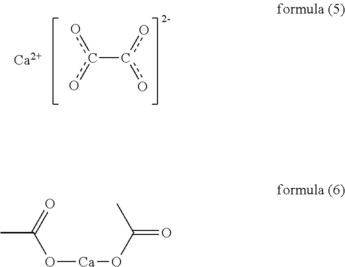

Based on the total weight of the mixture (A), a content of the second component (c) is from 1 to 20 wt %, preferably from 5 to 15 wt %, and more preferably about 10 wt %.

The catalyst (d) refers to a substance capable of speeding up the reaction rate of the first compound (a), the cross-linking agent (b) and the second compound (c) of the mixture (A), but does not react with the above components or produce by-products.

In some embodiments, the catalyst (d), for example, includes triphenylphosphine (TPP) or imidazole, however the invention is not limited thereto. Based on the total weight of the mixture (A), a content of the catalyst (d) is from 0 to 10 wt %.

Solvent (B)

The solvent (B) refers to a solvent capable of dissolving the first compound (a), the cross-linking agent (b), the second compound (c), and the catalyst (d), but does not react with the components, and preferably has a suitable volatility. In some embodiments, the specific examples of the solvent (B) is toluene, ethyl acetate (EAC), methyl ethyl ketone (MEK), or a combination thereof.

Based on a usage amount of 100 parts by weight of the mixture (A), a usage amount of the solvent (B) can be 20 parts by weight to 80 parts by weight, and preferably 50 parts by weight to 80 parts by weight.

<Method for Preparing Adhesive Composition>

In some embodiments, a method that can be used to prepare the adhesive composition includes, for instance: placing and stirring the mixture (A) and the solvent (B) in a stirrer such that the compositions are uniformly mixed into a solution state, the adhesive composition in a solution state can be obtained.

In addition, the method for preparing the adhesive composition is not particularly limited. The method for preparing the adhesive composition may include, for instance, first dispersing the first component (a), the cross-linking agent (b), and the second component (c) of the mixture (A) in the solvent (B) to form a dispersion solution, and then mixing the catalyst (d) and the above dispersion solution to prepare and obtain the adhesive composition in a solution state.

Alternatively, the adhesive composition can also be prepared by first dispersing first dispersing the catalyst (d) in the solvent (B) to form a dispersion solution, and then mixing the first component (a), the cross-linking agent (b), and the second component (c) of the mixture (A) and the above dispersion solution to prepare and obtain the adhesive composition in a solution state. The invention is not particularly limited thereto.

In some embodiments, under the premise of not affecting the efficacy of the invention, the adhesive composition of the invention can optionally further include an additive. For example, in some embodiments, as needed, the additive may be added during the preparing process of the adhesive composition in a solution state, or the additive may be added after the adhesive composition in a solution state is prepared, the invention does not pose any limitation thereto. Furthermore, the solvent (B) is capable of dissolving the additive, but does not react with the additive.

It is worth mentioning that, as the second component (c) comprised in the adhesive composition of the invention is capable of reacting with the corrosive substances, the second component (c) has corrosion resistance. Specifically, in some embodiments, the corrosive substances, for example, may be nitric acid, acetic acid, sulfuric acid, phosphoric acid, hydrochloric acid, hydrofluoric acid or sulfonic acid. Besides, the adhesive composition of the invention is also capable of having good adhesion.

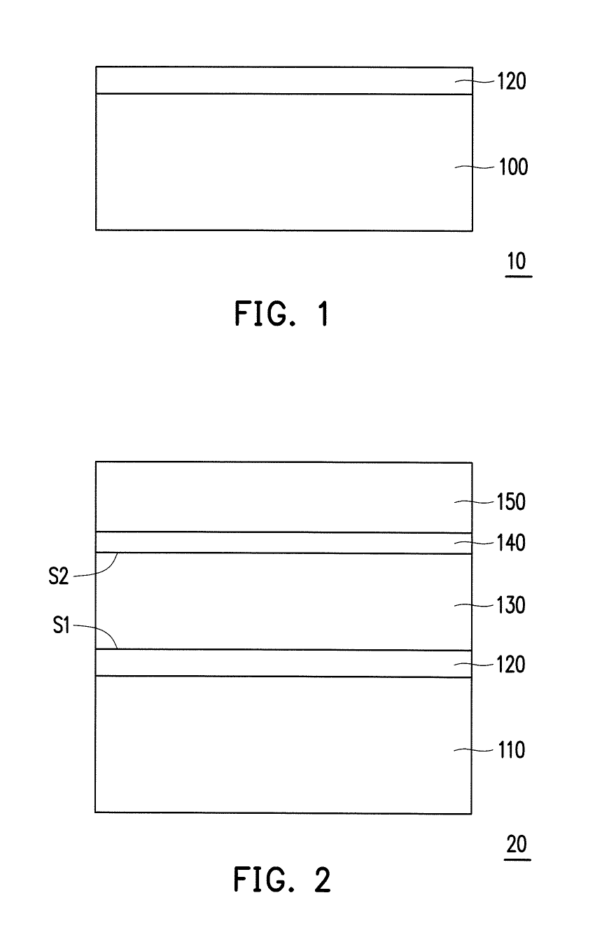

FIG. 1 is a schematic cross-sectional view illustrating a laminated film according to an embodiment of the invention. Referring to FIG. 1, a laminated film 10 includes a substrate 100 and an adhesive glue layer 120. In some embodiments, a material of the substrate 100 is, for example, metals, organic materials, or inorganic materials, the invention is not limited thereto.

As shown in FIG. 1, the adhesive glue layer 120 is disposed on the substrate 100, wherein the adhesive glue layer 120 is composed of the aforesaid adhesive composition. The description regarding the aforesaid adhesive composition can be found above, and a repeated description of the same technical contents is omitted. In some embodiments, a formation of the adhesive glue layer 120, for example, includes uniformly coating the adhesive composition in a solution state on the substrate 100 by a coating method such as die coating, micro gravure (MG) coating, spin coating or cast coating to from a coating layer. After the coating layer is formed, a drying process is further preformed. The drying process, for example, includes a method of direct heating, or air drying with compressed air or compressed nitrogen gas. The invention is not limited thereto. Furthermore, it is worth mentioning that, the adhesive glue layer 120 is formed by the adhesive composition of the invention, wherein the second component (c) comprised in the adhesive composition of the invention is capable of reacting with the corrosive substances such as nitric acid, acetic acid, sulfuric acid, phosphoric acid, hydrochloric acid, hydrofluoric acid or sulfonic acid, thus the adhesive glue layer 120 has good corrosion resistance in addition to good adhesion.

Based on the above, the adhesive glue layer 120 of the laminated film 10 of the invention has good corrosion resistance and good adhesion, so that the corrosive substances located on one side of the adhesive glue layer 120 can be rapidly adsorbed by the adhesive glue layer 120, which protects the substrate 100 located on another side of the adhesive glue layer 120 from being corroded by the corrosive substances. Therefore, the laminated film 10 of the invention has good corrosion resistance and can be used as a laminate in various industrial fields requiring high adhesion strength and corrosion resistance.

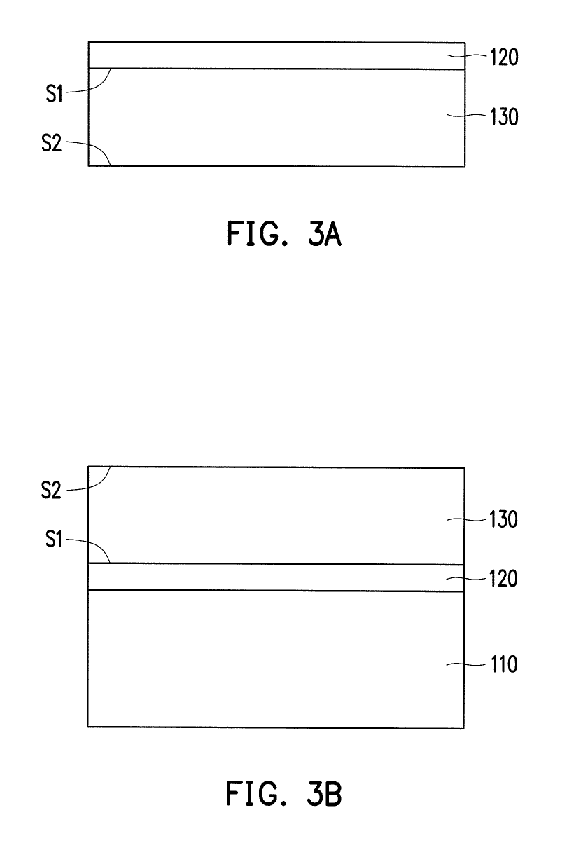

FIG. 2 is a schematic cross-sectional view illustrating a laminated film according to another embodiment of the invention. Referring to FIG. 2, the laminated film 20 of the invention includes a first resin layer 110, an adhesive glue layer 120, a metal layer 130, and a second resin layer 150. In some embodiment, the laminated film 20 of the invention further includes an adhesive layer 140. In the embodiment described below, the laminated film 20 is discussed as an aluminum plastic film for packaging the lithium ion battery as an exemplary example, and the detailed structure of the above layers will be elaborated in following descriptions. However, the invention is not limited thereto.

Referring to FIG. 2, the metal layer 130 has a first surface S1 and a second surface S2 opposite to each other. In the embodiment, a material of the metal layer 130 includes an aluminum film, which is capable of having a functionality of isolation and preventing water vapor. In one embodiment, a thickness of the metal layer 130 is between about 30 μm (micrometer) to 40 μm.

The first resin layer 110 acts as an inner layer of the laminated film 20 and is disposed on the first surface S1 of the metal layer 130. Specifically, the first resin layer is used as an isolation film to cover a battery core, so that the metal layer 130 is separated from the battery core (including positive electrode, negative electrode and electrolyte). In one embodiment, a thickness of the first resin layer 110 is between about 20 μm to 80 μm, the invention is not limited thereto. In some embodiments, a material of the first resin layer 110, for example, includes polypropylene (PP).

The adhesive glue layer 120 is located between the metal layer 130 and the first rein layer 110. In one embodiment, a thickness of the adhesive glue layer 120 is between about 3 μm to 5 μm. In the embodiment, the adhesive glue layer 120 is composed of the aforesaid adhesive composition. The description regarding the aforesaid adhesive composition can be found above, and a repeated description of the same technical contents is omitted. It is worth mentioning that, the adhesive glue layer 120 is formed by the adhesive composition of the invention, wherein the second component (c) comprised in the adhesive composition of the invention is capable of reacting with the corrosive substances such as nitric acid, acetic acid, sulfuric acid, phosphoric acid, hydrochloric acid, hydrofluoric acid or sulfonic acid, thus the adhesive glue layer 120 has good corrosion resistance in addition to good adhesion.

The second resin layer 150 is disposed on the second surface S2 of the metal layer 130. The second resin layer 150 acts as a protect film of the laminated film 20 to maintain high puncture resistance of aluminum plastic film and high formability of the lithium ion battery. Specifically, the metal layer 130 is located between the first resin layer 110 and the second resin layer 150. In one embodiment, a thickness of the second resin layer 150 is between about 15 μm to 25 μm. In one embodiment, a material of the second resin layer 150, for example, includes nylon, however the invention is not limited thereto.

The adhesive layer 140 is located between the metal layer 130 and the second resin layer 150. In one embodiment, a thickness of the adhesive layer 140 is between about 3 μm to 5 μm. In one embodiment, a material of the adhesive layer 140, for example, includes modified acrylic resin, however the invention is not limited thereto.

Based on the above, in the laminated film of the invention, the second component (c) comprised in the adhesive glue layer 120 is capable of reacting with the corrosive substances, so that the corrosive substances located on one side of the adhesive glue layer 120 can be rapidly adsorbed by and reacted with the adhesive glue layer 120, which makes the corrosiveness of the corrosive substances weaken, thereby protecting the metal layer 130 located on another side of the adhesive glue layer 120 from being corroded by the corrosive substances. Therefore, with the adhesive glue layer 120 of the laminated film, the metal layer 130 can avoid directly contact with the corrosive substances (e.g., the acidic substances generated from the electrolytic solution of the lithium ion battery, such as hydrofluoric acid), so that the laminated film of the invention has good corrosive resistance.

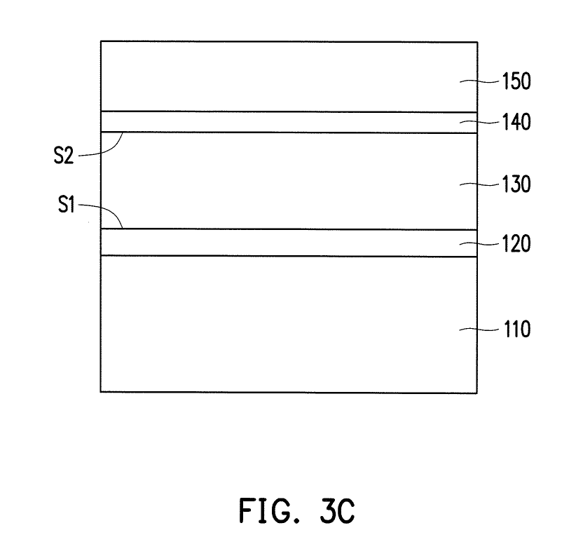

A manufacturing method of the laminated film 20 would be discussed in detail as follows. FIG. 3A to 3C are schematic cross-sectional view illustrating the processes of a method of fabricating a laminated film according to an embodiment of the invention.

First, referring to FIG. 3A, a metal layer 130 is provided, wherein the metal layer 130 has a first surface S1 and a second surface S2 opposite to each other. In the embodiment, a material of the metal layer 130 includes an aluminum film. In one embodiment, a thickness of the metal layer 130 is between about 30 μm to 40 μm. However, the invention is not limited thereto.

Then, a first resin layer 110 is provide and an adhesive glue layer 120 is formed on the first surface S1 of the metal layer 130, so that the first resin layer 110 is adhered to the first surface S1 of the metal layer 130, as shown in FIG. 3B. In some embodiments, the formation of the adhesive glue layer 120, for example, includes uniformly coating the aforesaid adhesive composition in a solution state on the first surface S1 of the metal layer 130 to form a coating layer; then after the coating layer is formed, performing a drying process to form the adhesive glue layer 120 located between the first resin layer 110 and the first surface S1 of the metal layer 130. The drying process, for example, includes a method of direct heating, or air drying with compressed air or compressed nitrogen gas, and the coating method, for example, includes micro gravure (MG) coating, roll coating, blade coating, slide coating, slot die coating or wire bar coating, which however should not be construed as a limitation to the invention. On the other hand, in other embodiments, the adhesive glue layer 120 can be formed on the first resin layer 110 to adhere the first resin layer 110 to the first surface S1 of the metal layer 130; the invention is not limited thereto. In one embodiment, a thickness of the adhesive glue layer 120 is between about 3 μm to 5 μm. In one embodiment, a material of the first resin layer 110, for example, includes polypropylene (PP), and a thickness of the first resin layer 110 is between about 20 μm to 80 μm, the invention is not limited thereto.

Lastly, a second resin layer 150 is formed on the second surface S2 of the metal layer 130, as shown in FIG. 3C. Specifically, the second resin layer 150 is provided; and by a coating process, an adhesive layer 140 is coated on a surface of the second resin layer 150 or the second surface S2 of the metal layer 130, so that the second resin layer 150 is adhered to the second surface S2 of the metal layer 130 through the adhesive layer 140. The metal layer 130 is located between the first resin layer 110 and the second resin layer 150. Up to here, the fabrication of the laminated film 20 in the invention is completed.

Furthermore, in the manufacturing method described above, the first resin layer 110 is formed on the metal layer 130 before the second resin layer 150 is formed on the metal layer 130, however the invention is not limited thereto. In other embodiments, the first resin layer 110 may be formed on the metal layer 130 after the second resin layer 150 may be formed on the metal layer 130.

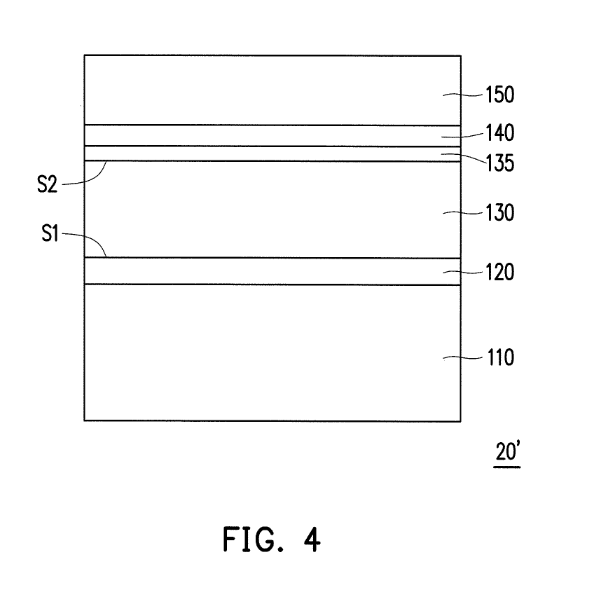

FIG. 4 is a schematic cross-sectional view illustrating a laminated film according to another embodiment of the invention. The laminated film 20′ depicted in FIG. 4 is similar to the laminated film 20 depicted in FIG. 2; therefore, the identical or similar devices in these drawings are represented by the identical or similar reference numbers, and the materials and the manufacture of the devices will not be further explained. The difference between the laminated film 20′ depicted in FIG. 4 and the laminated film 20 depicted in FIG. 2 lies in that the laminated film 20′ further includes a metal treatment layer 135.

Specifically, as shown in FIG. 4, the metal treatment layer 135 is located between the metal layer 130 and the adhesive layer 140. In one embodiment, a thickness of the metal treatment layer 135 is between about 10 nm (nanometer) to 200 nm. In some embodiments, the formation of the metal treatment layer 135, for example, includes performing a metal treatment process on the second surface S2 of the metal layer 130 to form the metal treatment layer 135 having a thin coating on the second surface S2 of the metal layer 130. The metal treatment process, for example, includes die coating, dipping coating, a film treatment or a coating treatment, which however should not be construed as a limitation to the invention. More specifically, prior to forming the adhesive glue layer 120, the metal treatment layer 135 is formed on the second surface S2 of the metal layer 130, wherein the metal treatment layer 135 is anti-corrosive.

Experimental examples 1-3 of the laminated film of the invention and comparative examples 1-2 are described below:

Table 1 shows the components and the content thereof used in the adhesive composition of Examples 1-5.

TABLE 1

| COM- | | | | | |
|---|---|---|---|---|---|
| PONENTS | Example 1 | Example 2 | Example 3 | Example 4 | Example 5 |
| Mixture (A) | | | | | |
| first | SEBS | SEBS | SEBS | SEBS | SEBS |
| component | 40 wt % | 30 wt % | 20 wt % | 30 wt % | 30 wt % |
| (a) | | | | | |
| cross-linking | epoxy | epoxy | epoxy | epoxy | epoxy |
| agent (b) | 58.6 wt % | 64.6 wt % | 69.6 wt % | 64.6 wt % | 64.6 wt % |
| second | formula | formula | formula | calcium | calcium |
| component | (6) | (1) | (2) | carbonate | lactate |
| (c) | 1 wt % | 5 wt % | 10 wt % | 5 wt % | 5 wt % |
| catalyst (d) | TPP | imidazole | imidazole | TPP | TPP |
| | 0.40 wt % | 0.40 wt % | 0.40 wt % | 0.40 wt % | 0.40 wt % |
| Solvent (B) | toluene | toluene | toluene | toluene | toluene |

SEBS: styrene ethylene butylene styrene
Epoxy: an aliphatic compound having epoxy group as the reactive functional group
TPP: triphenylphosphine
*: based on a usage amount of 100 parts by weight of the mixture (A), a usage amount of the solvent (B) is about 60 parts by weight.

Please refer to the structure and manufacturing method of the laminated film as described above. The features of the invention are more specifically described in the following with reference to the experimental examples 1-3. Although the following experimental examples 1-3 are described, the materials used and the amount and ratio thereof, as well as handling details and handling process . . . etc., can be suitably modified without exceeding the scope of the invention. Accordingly, restrictive interpretation should not be made to the invention based on the examples described below.

### EXPERIMENTAL EXAMPLE 1

At room temperature, the adhesive composition in a solution state (i.e., Example 1 of Table 1) was coated on an aluminum film having a thickness of 40 μm by a blade coating. After that, a drying process was performed to form an adhesive glue layer. Then, a surface of the aluminum film, which was coated with the adhesive glue layer, was faced toward to and placed on a polypropylene film (which acts as an inner layer) to adhere the aluminum fil and the polypropylene film through the adhesive glue layer. A thickness of the adhesive glue layer was about from 3 μm to 5 and a thickness of the polypropylene film was about 40 μm. Afterward, at room temperature, another surface of the aluminum film opposite to the adhesive glue layer was coated with modified acrylate resin to form an adhesive layer, and a nylon film was adhered to the aluminum film through the adhesive layer composed of the modified acrylate resin. A thickness of the adhesive layer was about 3 μm to 5 μm, and a thickness of the nylon film was about 25 μm. With the above steps, the laminated film of Experimental Example 1 was finished.

### EXPERIMENTAL EXAMPLE 2 AND EXPERIMENTAL EXAMPLE 3

The laminated films of Experimental Example 2 and Experimental Example 3 were manufactured according to a similar manufacturing process of Experimental Example 1, and the difference lies only in that an adhesive glue layer of Experimental Example 2 was formed by the adhesive composition indicated as Example 2 of Table 1, and an adhesive glue layer of Experimental Example 3 was formed by the adhesive composition indicated as Example 3 of Table 1.

### COMPARATIVE EXAMPLE 1 AND COMPARATIVE EXAMPLE 2

The structures of laminated films of Comparative Example 1 and Comparative Example 2 can be referred to the laminated film depicted in FIG. 2. The laminated films of Comparative Example 1 and Comparative Example 2 were manufactured according to a similar manufacturing process of Experimental Example 1, and the difference lies only in that an adhesive glue layer of Comparative Example 1 was formed by the adhesive composition indicated as Example 4 of Table 1, and an adhesive glue layer of Comparative Example 2 was formed by the adhesive composition indicated as Example 5 of Table 1.

Table 2 shows the materials and the thickness of each layer in the laminated films of the Experimental Examples 1-3 and Comparative Examples 1-2.

TABLE 2

| | | Experimental | Experimental | Experimental | Comparative | Comparative |
|---|---|---|---|---|---|---|
| | | Example 1 | Example 2 | Example 3 | Example 1 | Example 2 |
| outer layer | material | nylon | nylon | nylon | nylon | nylon |
| | thickness | 25 μm | 25 μm | 25 μm | 25 μm | 25 μm |
| adhesive layer | material | modified | modified | modified | modified | modified |
| | | acrylate resin | acrylate resin | acrylate resin | acrylate resin | acrylate resin |
| | thickness | 3-5 μm | 3-5 μm | 3-5 μm | 3-5 μm | 3-5 μm |
| metal layer | material | aluminum | aluminum | aluminum | aluminum | aluminum |
| | thickness | 40 μm | 40 μm | 40 μm | 40 μm | 40 μm |
| adhesive glue layer | material | Example 1^{a} | Example 2^{a} | Example 3^{a} | Example 4^{a} | Example 5^{a} |
| | thickness | 3-5 μm | 3-5 μm | 3-5 μm | 3-5 μm | 3-5 μm |
| inner layer | material | polypropylene | polypropylene | polypropylene | polypropylene | polypropylene |
| | thickness | 40 μm | 40 μm | 40 μm | 40 μm | 40 μm |

^{a}see Table 1

<Measurement of Peel Strength >

First, the laminated film of each of Experimental Examples 1 to 3 and Comparative Examples 1-2 was cut into a test specimen having a width of 15 mm (millimeter). Then, each of the test specimen was stretched to a stretch length of 50 mm using a universal testing machine (AG-1S made by Shimadzu Scientific Instruments Co., Ltd.) under the condition of a tensile speed set to 50 mm/min and a tensile angle set to 180 degrees, wherein the stretch length of 50 mm was a mean value of six specimens for each of Experimental Examples 1 to 3 and Comparative Examples 1-2. Furthermore, based on the standard of the industries, the peel strength between the metal layer and the inner layer needs to be greater than 5N/15 mm. Therefore, in the test, if the peel strength between the metal layer and the inner layer was greater than 5N/15 mm, then “∘” is indicated in Table 3, and if the peel strength between the metal layer and the inner layer was less than or equal to 5N/15 mm, then “×” is indicated in Table 3.

<Forming Depth Test>

First, the laminated film of each of Experimental Examples 1 to 3 and Comparative Examples 1-2 was cut into a test specimen having an area of 8 cm×10 cm. Then, each of the test specimen was undergoing deep drawing to a length greater than 5 mm by a cool punch process under 6 kg (kilogram). After the cool punch process, if the test specimen was not broken or did not have delamination defect, then “∘” is indicated in Table 3, and if the test specimen was broken or had delamination defect, then “×” is indicated in Table 3.

<Electrolyte Resistance-1>

First, the laminated film of each of Experimental Examples 1 to 3 and Comparative Examples 1-2 was cut into a test specimen having an area of 10 cm×10 cm. Then, the inner layer of each of the test specimen was immersed in an electrolytic solution (DEC/EMC/EC =1/1/1 (wt %) +LiPF₆) under a temperature of 85 degrees Celsius and stayed for 1 day. After 1 day, the peel strength between the metal layer and the inner layer was measured. In the test, if the peel strength between the metal layer and the inner layer was greater than 3N/15 mm, then “∘” is indicated in Table 3, and if the peel strength between the metal layer and the inner layer was less than or equal to 3N/15 mm, then “×” is indicated in Table 3.

<Electrolyte Resistance-2>

First, the laminated film of each of Experimental Examples 1 to 3 and Comparative Examples 1-2 was cut into a test specimen having an area of 10 cm×10 cm. Then, the inner layer of each of the test specimen was immersed in an electrolytic solution (DEC/EMC/EC=1/1/1 (wt %)+LiPF₆) under a temperature of 75 degrees Celsius and stayed for 7 days. After 7 days, the peel strength between the metal layer and the inner layer was measured. In the test, if there is delamination defect, then “∘” is indicated in Table 3, and if there is no delamination defect, then “×” is indicated in Table 3.

<Heat Seal Strength Test>

First, the laminated film of each of Experimental Examples 1 to 3 and Comparative Examples 1-2 was cut into a test specimen having a width of 15 mm. Then, each of the test specimens was undergoing a thermal sealing process under high temperature and high pressure, so that the inner layer of each of the test specimens was joined together itself (e.g., two different ends/sides of the inner layer of each of the test specimens were welded to each other under a high-temperature and high-pressure process). The inner layer-inner layer interface of each of the test specimens was stretched to a stretch length of 50 mm using a universal testing machine (AG-1S made by Shimadzu Scientific Instruments Co., Ltd.) under the condition of a tensile speed set to 50 mm/min and a tensile angle set to 180 degrees. In the test, if the peel strength of inner layer-inner layer interface was greater than 50N/15 mm, then “∘” is indicated in Table 3, and if the peel strength of inner layer-inner layer interface was less than or equal to 50N/15 mm, then “×” is indicated in Table 3.

Table 3 shows the evaluation results of the laminated films of the Experimental Examples 1-3 and Comparative Examples 1-2.

TABLE 3

| | Experimental | | | Comparative | |
|---|---|---|---|---|---|
| | Examples | | | Examples | |
| | 1 | 2 | 3 | 1 | 2 |
| Measurement of peel strength | ∘ | ∘ | ∘ | ∘ | ∘ |
| Forming depth test | ∘ | ∘ | ∘ | ∘ | ∘ |
| Electrolyte resistance-1 | ∘ | ∘ | ∘ | x | x |
| Electrolyte resistance-2 | ∘ | ∘ | ∘ | x | x |
| Heat seal strength test | ∘ | ∘ | ∘ | ∘ | ∘ |

According to Table 3, as compared to Comparative Examples 1-2, the laminated films of Experimental Example 1-3 have better performance in the tests such as the measurement of peel strength, the forming depth test, the electrolyte resistance-1, the electrolyte resistance-2, and the heat seal strength test as described above. Therefore, it can be known that the laminated film of the invention has the advantages of corrosive resistance in addition to high chemical resistance and formability.

In other to prove that the laminated film of the invention, which may be used for packaging the lithium ion battery, can improve the delamination defects caused by erosion of acidic substances generated from the electrolytic solution of the lithium ion battery, several tests (such as an aging test under high temperature, a wetting resistant test, an electrical insulation test, and a corrosion resistance) were performed.

In the tests, the laminated film of the invention was used as an aluminum plastic film for packaging the lithium ion battery (3370090 model, capacity: 18500 mAh) having a thickness of 113 μm.

In the aging test under high temperature, there is no deformation or delamination observed from the appearance of the lithium ion battery after being placed in a hot water bath (of 75 degrees Celsius) for 24 hours, 48 hours and 72 hours. In the wetting resistant test, the lithium ion battery was placed in in a water bath (at room temperature) for 20 days, and no bubbling inside the lithium ion battery is observed. Further, the lithium ion battery also passed the electrical insulation test (e.g., having a voltage difference between the positive electrode of the lithium ion battery and the aluminum plastic film (i.e., the laminated film) less than 2 volts) and the corrosion resistance (e.g., placing the lithium ion battery in a 60% humidity environment at 45 degrees Celsius for 4 days; and no delamination defect is observed after 4 days).

Based on the above, the adhesive composition of the invention has corrosion resistance, as such the adhesive glue layer made from the adhesive composition of the invention is capable of having good corrosion resistance in addition to good adhesion. Accordingly, the laminated film having the same is anti-corrosive, which is capable of achieving the effect of corrosion resistance, thereby enhancing the lifetime and safety of the laminated film.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. An adhesive composition, comprising:
a mixture (A), comprising:
a first component (a);
a cross-linking agent (b); and
a second component (c); wherein the second component (c) includes a calcium-containing complex compound or a calcium-containing compound, the calcium-containing complex compound is selected from the group consisting of a compound represented by formula (1), a compound represented by formula (2), a compound represented by formula (3), and a compound represent by formula (4), 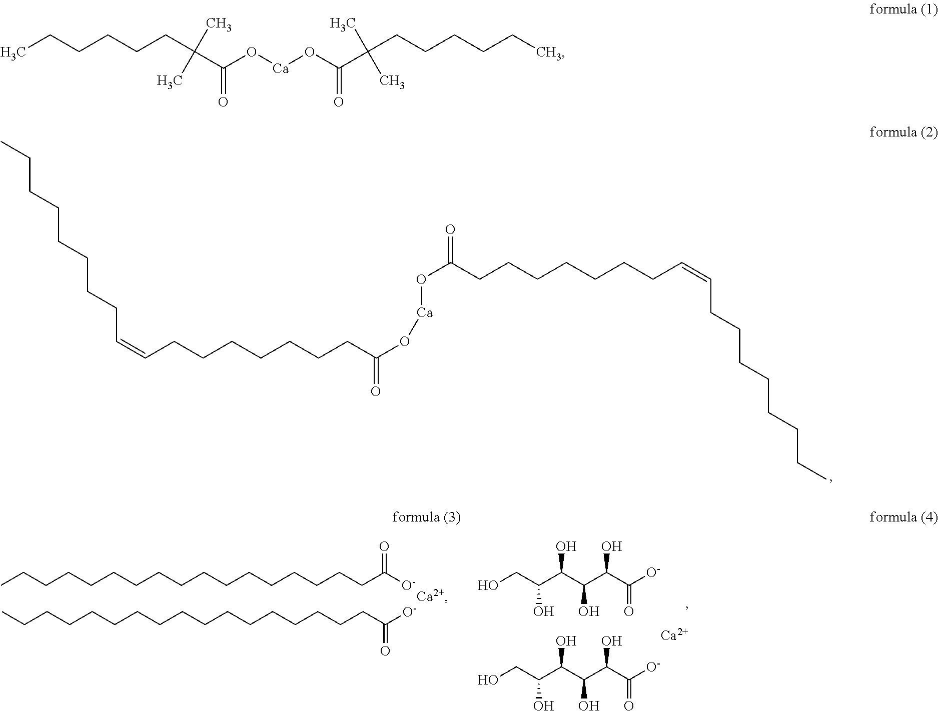
and the calcium-containing compound is selected from the group consisting of a compound represented by formula (5) and a compound represent by formula (6), 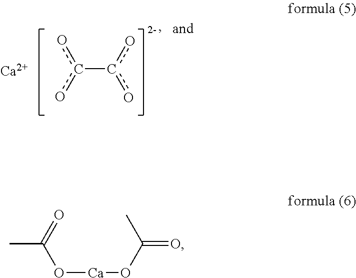
wherein based on the total weight of the mixture (A), a content of the first component (a) is from 40 to 80 wt %, a content of the cross-linking agent (b) is from 20 to 60 wt %, and a content of the second component (c) is from 1 to 20 wt %.

2. The adhesive composition according to claim 1, wherein the first component (a) comprises a resin having a reactive functional group, wherein the reactive function group is selected from the group consisting of a carboxy group, an amino group, an epoxy group, a hydroxy group and a double bond.

3. The adhesive composition according to claim 1, wherein the cross-linking agent (b) comprises an aromatic compound having at least two reactive functional groups, an aliphatic compound having at least two reactive functional groups, and a combination thereof, wherein the reactive functional groups is selected from the group consisting of a carboxy group, an anhydride group, an amino group, a hydroxy group, epoxy group, an isocyanate group and a double bond.

4. The adhesive composition according to claim 1, further comprising a catalyst (d), wherein based on the total weight of the mixture (A), a content of the catalyst (d) is from 0 to 10 wt %.

5. The adhesive composition according to claim 1, further comprising a solvent (B), wherein based on 100 wt % of the mixture (A), a content of the solvent (B) is from 20 to 80 wt %.

6. A laminated film, comprising:
a substrate; and
an adhesive glue layer disposed thereon, wherein the adhesive glue layer is formed by the adhesive composition of claim 1.

7. The laminated film according to claim 6, wherein a material of the substrate is selected from the group consisting of metals, organic materials and inorganic materials.

8. A laminated film, comprising:
a metal layer, wherein metal layer has a first surface and a second surface opposite to each other;
a first resin layer, wherein the first resin layer is disposed on the first surface of the metal layer
a second resin layer, wherein the second resin layer is disposed on the second surface of the metal layer; and
an adhesive glue layer, wherein the adhesive glue layer is disposed between the metal layer and the first resin layer, wherein the adhesive glue layer is formed by an adhesive composition comprising a mixture (A), and the mixture (A) comprises:
a mixture (A), comprising:
a first component (a);
a cross-linking agent (b); and
a second component (c); wherein the second component (c) includes a calcium-containing complex compound or a calcium-containing compound, the calcium-containing complex compound is selected from the group consisting of a compound represented by formula (1), a compound represented by formula (2), a compound represented by formula (3), and a compound represent by formula (4), 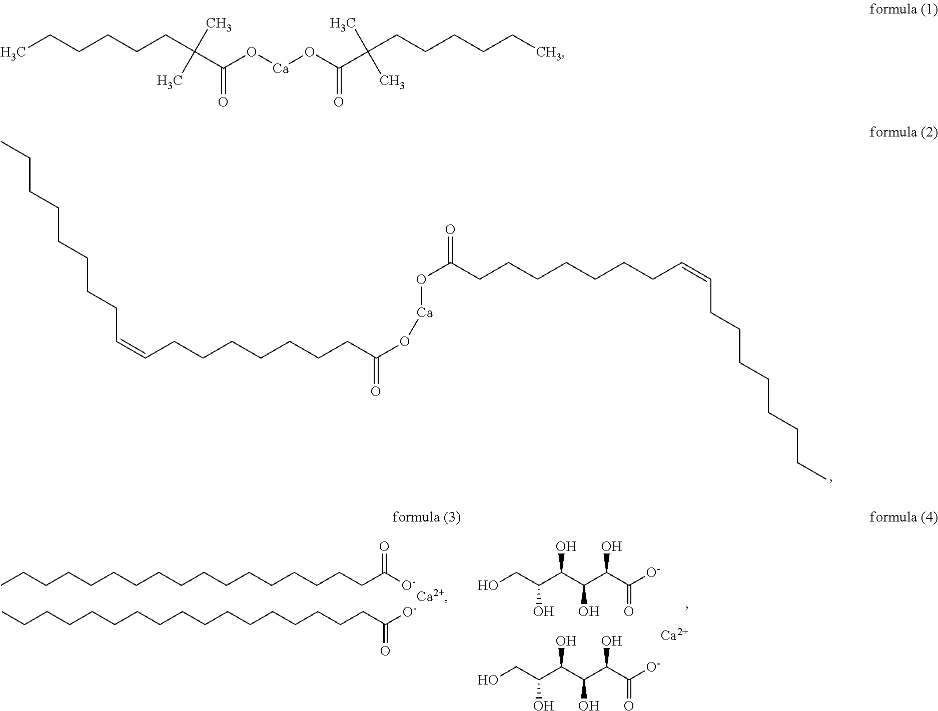
and the calcium-containing compound is selected from the group consisting of a compound represented by formula (5) and a compound represent by formula (6), 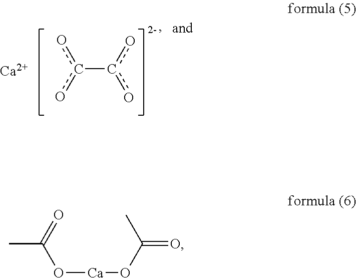
wherein based on the total weight of the mixture (A), a content of the first component (a) is from 40 to 80 wt %, a content of the cross-linking agent (b) is from 20 to 60 wt %, and a content of the second component (c) is from 1 to 20 wt %.

9. The adhesive composition according to claim 8, wherein the first component (a) includes a resin having a reactive functional group, wherein the reactive function group is selected from the group consisting of a carboxy group, an amino group, an epoxy group, a hydroxy group and a double bond.

10. The adhesive composition according to claim 8, wherein the cross-linking agent (b) includes an aromatic compound having at least two reactive functional groups, an aliphatic compound having at least two reactive functional groups, and a combination thereof, wherein the reactive functional groups is selected from the group consisting of a carboxy group, an anhydride group, an amino group, a hydroxy group, epoxy group, an isocyanate group and a double bond.

11. The adhesive composition according to claim 8, further comprising a catalyst (d), wherein based on the total weight of the mixture (A), a content of the catalyst (d) is from 0 to 10 wt %.

12. The adhesive composition according to claim 8, further comprising a solvent (B), wherein based on 100 wt % of the mixture (A), a content of the solvent (B) is from 20 to 80 wt %.

13. The adhesive composition according to claim 8, wherein a thickness of the metal layer is between about 30 μm to 40 μm.

14. The adhesive composition according to claim 8, wherein a thickness of the first resin layer is between about 20 μm to 80 μm.

15. The adhesive composition according to claim 8, wherein a thickness of the second resin layer is between about 15 μm to 25 μm.

16. The adhesive composition according to claim 8, wherein a thickness of the adhesive glue layer is between about 3 μm to 5 μm.

17. The adhesive composition according to claim 8, further comprising an adhesive layer disposed between the metal layer and the second resin layer, wherein a thickness of the adhesive layer is between about 3 μm to 5 μm.

18. The adhesive composition according to claim 17, further comprising a metal treatment layer disposed between the metal layer and the adhesive layer, wherein a thickness of the metal treatment layer is between about 10 nm to 200 nm.
